(19) United States
(12) Patent Application Publication
(10) Pub. No.: US 2026/0257916 A1
(43) Pub. Date: Sep. 3, 2026

(54) METHOD OF REMOVING ONE OR MORE TARGET IMPURITIES FROM CRUDE FLUOROSULFONYLIMIDE COMPOUND

(71) Applicant: SPECIALTY OPERATIONS FRANCE, Lyon (FR)

(72) Inventors: Elie Derrien, Brignais (FR); Eric Perin, Pont-Evêque (FR)

(73) Assignee: SPECIALTY OPERATIONS FRANCE, Lyon (FR)

(21) Appl. No.: 19/489,445

(22) PCT Filed: May 31, 2024
(86) PCT No.: PCT/EP2024/064991

§ 371 Date: Dec. 2, 2025

(30) Foreign Application Priority Data
Jun. 2, 2023 (EP) 23305878.3

(51) Int. Cl. C01B 21/093

(52) U.S. Cl. CPC C01B 21/0935; C01P 2006/80

(57) ABSTRACT

The invention relates to a method of removing one or more target chlorinated impurities from crude bis(fluorosulfonyl)imide mixture containing a hydrogen (bisfluorosulfonyl)imide compound, and the one or more target impurities so as to create a purified mixture by reacting said crude mixture in the molten phase with water or with an aqueous mineral acid.

### CROSS-REFERENCE TO RELATED PATENT APPLICATION(S)

The present invention claims priority from patent application No. 23305878.3, filed in Europe on 2 Jun. 2023, the whole content of this application being incorporated herein for all purposes.

### TECHNICAL FIELD

The invention relates to a method of removing one or more target chlorinated impurities from crude bis(fluorosulfonyl)imide mixture containing a hydrogen (bisfluorosulfonyl)-imide compound, and the one or more target impurities so as to create a purified mixture.

### BACKGROUND ART

Bis(fluorosulfonyl)imide and salts thereof, in particular the lithium salt of bis(fluorosulfonyl)imide (LiFSI), are useful compounds in a variety of technical fields.

Bis(fluorosulfonyl)imide salts are especially useful in battery electrolytes.

Bis(fluorosulfonyl) imide (HFSI, of formula HN(SO₂F)₂) is a well-known intermediate in the production of second generation battery salts (e.g. LiFSI or NaFSI); various synthetic routes for preparing HFSI have been proposed; several synthetic routes involve chlorinated intermediates; in particular, HFSI may be manufactured by fluorination of bis(chlorosulfonyl) imide (HCSI), with various fluorinating agents, in particular by nucleophilic fluorination, e.g. using HF, AsF₃, BiF₃, SbF₃ as fluorinating agents (see Eq. 1 and Eq. 2 below):

$$3 {HN ( {SO}_{2} Cl )}_{2} + 2 {M}^{′} {F}_{3} \to 3 {HN ( {SO}_{2} F )}_{2} + 2 {M}^{′} {CI}_{3} ( {M}^{′} = As , Sb , Bi ) \qquad Eq . l$$

or

$${HN ( {SO}_{2} Cl )}_{2} + 2 HF \to {HN ( {SO}_{2} F )}_{2} + 2 HCI \qquad Eq . 2$$

Regardless of the method of making it, manufacture of HFSI comes with the presence of several impurities that might remain in the final product (as such or transformed by the downstream process) and be detrimental to the performance of the FSI salt in battery applications. Chlorinated impurities bearing —SO₂Cl moieties such as bis(chlorosulfonyl) imide, (chlorosulfonyl fluorosulfonyl) imide, sulfamoyl chloride (NH₂SO₂Cl), chlorinated sulfonylimide oligomers such as F—SO₂—NH—SO₂—NH—SO₂—Cl and chlorosulfonic acid are critical impurities for that purpose, notably since they are precursors of chlorides ionic species.

While bis(chlorosulfonyl) imide (HCSI) has a significantly higher boiling point than bis(fluorosulfonyl) imide (HFSI), mixed fluoro/chloro analogous has intermediate boiling point, and chlorosulfonic acid has a boiling point of 152° C. Purification by fractional distillation may hence be complex and may require numerous theoretical plates (i.e. high CAPEX for industrialization), although being a widely known technique, referred notably in WO 2019/229357.

Alternative methodologies for the purification of HFSI have been suggested.

U.S. Pat. No. 10,734,664 to SES Holdings Pte. Ltd. discloses a method of removing impurities from a crude HFSI comprising crystallization pure HFSI from an organic anhydrous solvent, whiles impurities including HF, FSO₃H, HCl, H₂SO₄ remain in the solution phase. The method thereby described introduces organic solvents into the system, which is generally not desirable, because of the complexity which such addition may generate. Furthermore, no information is given on the purification efficiency related to e.g. ClSO₃H, HCSI and other chlorine-containing molecules, so its applicability/effectiveness remains challenging.

Further, U.S. Ser. No. 11/267,707 to HONEYWELL has proposed a method of producing purified bis(fluorosulfonyl) imide, said method including providing a liquid mixture including bis(fluorosulfonyl) imide and fluorosulfonic acid and then contacting the liquid mixture with gaseous ammonia, producing ammonium salts of certain acidic impurities. However, compounds bearing chlorosulfonic functions —SO₂Cl having lower pKa may not be selectively removed with this treatment (e.g. CSA or HCFSI). Further, this method requires the use of toxic, corrosive and flammable ammonia gas.

CN 113912028 to SHENZHEN XINCHEN NEW ENERGY TECH CO LTD., discloses a purification method of HFSI that is said to reduce the content of chlorine impurities and comprises the following steps: (1) under nitrogen protection, an acid or a salt thereof is added to HFSI crude product and the reaction is heated under stirring, (2) under pressure, perform distillation/rectification to obtain the HFSI with lower chloride content. The acid can be either inorganic (for example concentrated sulfuric acid, sulfamic acid, . . . ) or organic (for example oxalic acid, citric acid, tartaric acid, . . . ). This document however discloses water as an undesired compound, which should be limited and not higher than 3% in organic acid. Also, this document does not differentiate between organic acids and inorganic acids.

There is hence a shortfall in the art for an improved, efficient and economically effective method to remove certain chlorinated impurities from HFSI, without the use of toxic, dangerous or harmful solvents/reactants, which could supply high purity HFSI for use as a raw material in the production of lithium bis(fluorosulfonyl) imide.

### SUMMARY OF INVENTION

One object of the present invention is a method of at least partially removing one or more target chlorinated impurities bearing at least one —SO₂Cl moiety from a crude bis(fluorosulfonyl)imide (HFSI) mixture comprising:
(i) a compound of formula (I) F—SO₂—NH—SO₂—R¹ (I) wherein R¹ represents F or Cl; preferably R¹ is F; and
(ii) the one or more said target chlorinated impurities bearing at least one —SO₂Cl moiety [crude mixture (C-HFSI)];
so as to create a purified HFSI mixture [purified mixture (P-HFSI)], the method comprising:
Step (a)—melting the crude mixture (C-HFSI) at a temperature exceeding the melting point of compound of formula (I), so as to obtain a molten mixture [molten mixture (M-FSI)];
Step (b)—contacting the crude mixture (M-HFSI) with (b1) water or with (b2) an aqueous acidic solution comprising water and at least one mineral acid, wherein the amount of water is of at most 50 equivalent for the total equivalent of target impurities present in crude mixture (C-HFSI),
so as to cause at least partial hydrolysis of the said target chlorinated impurities; and
Step (c)—at least partially removing said hydrolysed target chlorinated impurities, so as to obtain a purified mixture [purified mixture (P-HFSI)].

The Applicant has surprisingly found that the method detailed above has the following advantages:
Providing high purity compound of formula (I), e.g. HFSI which simplifies downstream purification steps in the manufacture of FSI salts.
Absence of solvents (sustainability, HSE, final product quality)
Only hydrogen chloride and sulfuric derivatives are generated as side products which are easily separated (e.g. by distillation).
High purification rate in chlorosulfonyl derivatives.
Process in liquid phase (no solids management).
Mineral acids carrying water are cheap, easily fed in the reactor (liquid) and used in low amounts.
Reaction in mild conditions (room temperature, atmospheric pressure)
Subsequent distillation removes potential metal contaminants.
Water solution added fed-batch to control exothermic hydrolysis reaction.

### DISCLOSURE OF THE INVENTION

In the present disclosure:
the expressions “comprised between . . . and . . . ” as well as “ranging from . . . to . . . ” or the like should be understood as including the limits;
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

The step (a) of the method according to the invention consists in melting crude a compound of formula (I), and preferably melting bis(fluorosulfonyl)imide; bis(fluorosulfonyl)imide or HFSI may be used as raw material. It may be represented by the formula: F—SO₂—NH—SO₂—F.

As said, crude mixture (C-HFSI) comprises one or more than one target chlorinated impurity bearing at least one —SO₂Cl moiety. Chlorinated impurities bearing —SO₂Cl moieties which are advantageously at least partially removed via the method of the present invention are notably bis(chlorosulfonyl) imide, (chlorosulfonyl fluorosulfonyl) imide, sulfamoyl chloride (NH₂SO₂Cl), chlorinated sulfonylimide oligomers such as F—SO₂—NH—SO₂—NH—SO₂—Cl and chlorosulfonic acid.

The content of target chlorinated impurities in crude mixture (C-HFSI) is not particularly limited. The method of the present invention is effective for at least partial removal of the said target impurities in variable amounts. This said it is generally understood that crude mixture (C-HFSI) may comprise the target chlorinated impurities in an amount of at least 500 ppm, preferably of at least 1000 ppm, more preferably of at least 1500 ppm. Upper boundaries are not particularly limited, although it is practical for the crude mixture (C-HFSI) to comprise the target chlorinated impurities in an amount of at most 10 000 ppm, preferably of at most 8000 ppm, more preferably of at most 5000 ppm.

According to the present invention, in step (a), crude mixture (C-HFSI) containing compound of formula (I) and the one or more said target chlorinated impurities is molten, by raising the temperature beyond the melting point of compound (I); melting point of HFSI is about 17° C., which means heating in step (a) at a temperature exceeding about 17° C. when compound (I) is HFSI.

The choice of the temperature is not particularly critical, provided that the appropriate molten viscosity is achieved, for delivering the crude mixture (C-HFSI) in molten state in Step (b).

Generally, temperature in Step (a) is ranging between 17° C. and 120° C., preferably between 20° C. and 80° C., more preferably between 25° C. and 50° C.

Generally, crude mixture (C-HFSI) is molten under a protective atmosphere, notably under an atmosphere which is substantially exempt from moisture. The amount of moisture in step (a) is generally kept below 5,000 ppm, more preferably below 1,000 ppm, more preferably below 500 ppm, more preferably below 100 ppm even more preferably below 50 ppm, with respect to compound of formula (I).

As said, step (b) is generally carried out in the substantial absence of any diluent. This means that no diluent is added, and if any diluent residual is present, its amount is less than 1 wt. % based on the total weight of the molten mixture (M-HFSI).

As said, step (b) of the method of the present invention is a substantially diluent-free step. In other words, no solvent/diluent, alternatively a very low amount of diluent (aka solvent), is present in the mixture (M-HFSI) during the reaction of step (b). Carrying out step (b) without adding any further diluent is especially advantageous. Indeed, the use of diluent during such a step implies that the solvent(s) will have to be removed after reaction in order to obtain an as pure as possible product which can be used for battery applications. The step for removing the diluent adds to the complexity of the industrial process, as well as its overall cost. Deleterious reactions, which could occur between HFSI, its impurities or hydrogen chloride by-product formed in step (b) and the diluent possibly used, can be avoided. Additionally, because the step for removing the diluent is not needed for step (b), the present invention overall provides a simpler purification process, significantly decreasing the complexity of the industrial process, as well as its overall cost.

Preferably, the amount of diluent is less than 0.5 wt. %, less than 0.1 wt. %, less than 0.01 wt. %, or less than 0.001 wt. %, based on the total weight of the crude mixture (M-HFSI).

Diluents which are typically avoided are for example polar aprotic solvents, and may be selected from the group consisting of:
cyclic and acyclic carbonates, for instance ethylene carbonate, propylene carbonate, butylene carbonate, dimethyl carbonate, ethyl methyl carbonate, diethyl carbonate,
cyclic and acyclic esters, for instance gamma-butyrolactone, gamma-valerolactone, methyl formate, methyl acetate, methyl propionate, ethyl acetate, ethyl propionate, isopropyl acetate, propyl propionate, butyl acetate,
cyclic and acyclic ethers, for instance diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, 1,4-dioxane,
amide compounds, for instance N,N-dimethylformamide, N-methyl oxazolidinone,
sulfoxide and sulfone compounds, for instance sulfolane, 3-methylsulfolane, dimethylsulfoxide,
cyano-, nitro-, chloro- or alkyl-substituted alkane or aromatic hydrocarbon, for instance acetonitrile, valeronitrile, adiponitrile, benzonitrile, nitromethane, nitrobenzene.

As said, in Step (b) the molten mixture (M-HFSI) is contacted with (b1) water or with (b2) an aqueous acidic solution comprising water and at least one mineral acid.

Step (b) can be performed in any type of reaction vessel, which allows contacting the molten mixture (M-HFSI) with (b1) or (b2). Typically, a stirred vessel may be used, which is particularly adapted for ensuring intimate contact between molten HFSI and (b1) or (b2). Yet, the vessel may be not equipped with stirring means, but may be equipped with other means for ensuring such intimate contact in the molten mixture (M-HFSI), e.g. means for circulating the molten mixture (M-HFSI). The vessel may hence have any suitable three-dimensional shape, including a cylindrical shape or a tubular shape. The part of the vessel which are intended to come in contact with the molten mixture (M-HFSI) may be realized in any corrosion-resistance material; such as the alloys based on molybdenum, chromium, cobalt, iron, copper, manganese, titanium, zirconium, aluminum, carbon and tungsten, sold under the Hastelloy® brands or the alloys of nickel, chromium, iron and manganese to which copper and/or molybdenum are added, sold under the name Inconel® or Monel™, and more particularly the Hastelloy C276 or Inconel 600, 625 or 718 alloys. Stainless steels may also be selected, such as austenitic steels and more particularly the austenitic chromium-nickel stainless steel containing deliberate amount of molybdenum which increases general corrosion resistance and especially improves its pitting resistance to chloride ion solutions, being referred to as SS316, or its SS316L version, which is an extra-low carbon version of SS316 that minimizes harmful carbide precipitation during welding. A steel having a nickel content of at most 22% by weight, preferably of between 6% and 20% and more preferentially of between 8% and 14%, may be used. The 304 and 304L steels have a nickel content that varies between 8% and 12%, and the 316 and 316L steels have a nickel content that varies between 10% and 14%. Use may also be made of vessels consisting of or coated with a polymeric compound resistant to the corrosion of the molten mixture (M-HFSI). Mention may in particular be made of materials such as PTFE (polytetrafluoroethylene) or PFA (perfluoroalkyl resins). Glass equipment may also be used. It will not be outside the scope of the invention to use an equivalent material. As other materials capable of being suitable for being in contact with the molten mixture (M-HFSI), mention may also be made of graphite derivatives and ceramic materials.

Without being bound by this theory, the Applicant believes that during step (b), the water added as (b1) or (b2) causes the selective hydrolysis of the —SO₂Cl groups comprised in the target chlorinated impurities contained in the molten mixture (M-HFSI), according to the following reaction paths:

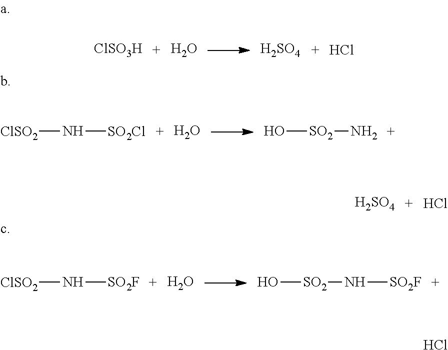

As —SO₂F groups are significantly less sensitive to hydrolysis, hydrolysis occurs in a selective manner, with substantially no impact on compound of formula (I), in particular on HFSI. Further, all formed hydrolysis products have volatility/boiling points which are significantly different from the compound of formula (I), and specifically from HFSI, making further purification steps easier.

As said, water can be added as such i.e. according to (b1) embodiment; as an alternative, it may be beneficial to add water as an aqueous solution of a mineral acid i.e. according to embodiment (b2). According to this embodiment, water is essentially added as diluted with a mineral acid, so decreasing the basicity of the water itself, and hence reducing kinetics and thermodynamics of the hydrolysis reactions. In this manner, exothermicity of the reaction is reduced, so favorably reducing any side decomposition reaction.

The said mineral acid is advantageous selected from the group consisting of (i) hydric acids of formula HX, with X being a halogen selected from Cl, F, Br, and I; and (ii) sulphuric acid; (iii) phosphoric and polyphosphoric acids; (iv) nitric acid; and (v) boric acid.

Preferably, the mineral acid may be selected from the group consisting of (i) hydric acids of formula HX, with X being a halogen selected from Cl, F, Br, and I; and (ii) sulphuric acid.

In case of (b2), use is generally made of concentrated mineral acid solutions. In case of hydrochloric acid, which is the preferred acid of formula HX, a concentration of at least 15% wt, preferably at least 20% wt, more preferably at least 30% wt in water is advantageously used. Fuming hydrochloric acid having concentration of up to 38% wt in water can be used. In case of sulphuric acid, concentrated solutions comprising up to 98% wt of sulphuric acid in water can be used. A sulphuric acid aqueous solution having a concentration of about 96% wt in water has been found to provide advantageous results, although sulphuric acid solutions of lower concentration may also be effective, and can advantageously limit the overall quantity of neat sulphuric acid used for providing water in the Step (b).

The water (b1) or the mixture (b2) is generally delivered to the reaction vessel of step (b) under the form of a liquid. Traditional means for delivering a liquid reactant into a liquid (molten) reaction mass can be advantageously employed.

As mentioned above, during step (b), hydrolysis may generate gaseous side-product such as HCl (irrespective of the use of (b1) or (b2)). HCl may be removed from the molten mixture (M-HFSI) by venting the reaction vessel whereas Step (b) takes place. According to this embodiment, a stream of inert gas, such as anhydrous nitrogen or anhydrous air, may be used for facilitating removal of HCl from the molten mixture (M-HFSI). As an alternative, removal of HCl may be facilitated by operating under reduced pressure, i.e. at a pressure which is inferior to ambient pressure (1 bar). This may be achieved by connecting the vessel comprising molten mixture (M-HFSI) to suction means.

Although the amount of HCl which is generated because of the hydrolysis of chlorinated target impurities is relatively limited, recovery of HCl may be effected via methods known in the art, for its valorization.

Step (b) is generally carried out at a temperature ranging from melting point of compound (I), preferably from melting point of HFSI, from about 17° C., to a temperature up to 100° C., preferably at a temperature of 20° C. to 50° C., even more preferably 20° C. to 30° C.

As said, the amount of water (via (b1) or (b2)) shall be controlled; indeed, the stoichiometry of water (via (b1) or (b2)) is important since compound of formula (I), such as HFSI, may, although with slower kinetics, undergoes hydrolysis phenomena.

An excess of water (via (b1) or (b2)) may be favorable for facilitating hydrolysis. Consistently, the amount of water may be of at most 50 equivalents, preferably of at most 25 equivalents, more preferably at most 10 equivalents, based on the total equivalents of target impurities present in crude mixture (C-HFSI). Yet, for avoiding unwanted hydrolysis reaction of compound of formula (I), and particularly of hydrogen bis(fluorosulfonyl)imide, an amount of at most 5, preferably at most 4, more preferably at most 3 equivalents, based on the total equivalents of target impurities present in crude mixture (C-HFSI) is preferred.

At least an equimolar amount has to be used; this said, as the water may be consumed by other hydrolysis reactions affecting other possibly hydrolysable impurities present in crude mixture (C-HFSI), preferably said amount is of at least 1.2, at least 1.5 equivalents, based on the total equivalents of target impurities present in crude mixture (C-HFSI). Very good results have been obtained when adjusting the amount of water in the range of 1.0 to 3.0 equivalents, based on the total equivalents of target impurities present in crude mixture (C-HFSI), preferably in the range of 1.5 to 2.5 equivalents, based on the total equivalents of target impurities present in crude mixture (C-HFSI).

The reaction in step (b) may be carried out in a batch, semi-batch or continuous modes; in batch mode, the vessel may be loaded with crude mixture (C-HFSI), and once the same is molten to give the molten mixture (M-HFSI), (b1) and/or (b2) may be added to the molten mixture (M-HFSI), and reacted until reaction is completed (e.g. notably when no longer evolution of HCl is detected). In a semi-batch arrangement, the vessel may be charged with crude mixture (C-HFSI), which, after being submitted to step (a) of melting, is reacted progressively with (b1) or (b2) which is added continuously, either step-wise or portion-wise, or by continuous addition, and the molten mixture (M-HFSI) may be reacted until completing the addition of (b1) and/or (b2). As a further alternative, molten mixture (M-HFSI) and (b1) and/or (b2) may be fed simultaneously in a continuous manner to the reaction vessel.

Step (c) comprises at least partially removing the hydrolysed compounds formed in Step (b), so as to obtain a purified mixture [purified mixture (P-HFSI)]. Purified mixture (P-HFSI) is generally obtained as a liquid phase.

The Step (c) of removing the hydrolysed compounds can be carried out according to standard techniques.

Step (c) may comprise a preliminary Step (c0) of contacting the mixture obtained from Step (b) with at least one Salt (S) of formula M^{p}Xₚ or M^{p}₂(SO₄)ₚ, whereas M^{p} is a metal cation of valence p or is an ammonium cation of valence p=1; X is a halide, preferably selected from Cl and Br, wherein the amount of Salt (S) is of 0.9 to 10 equivalent for each equivalent of target chlorinated impurities present in crude mixture (C-HFSI).

Indeed, as the water added as (b1) and/or (b2) is believed to cause the selective hydrolysis of the —SO₂Cl groups into sulfonic acid groups, as explained above, the Step (c0) may be beneficial for salifying the said acid compounds, and substantially decrease their volatility, by converting the same into corresponding sulfonic acid salt having groups of formula —SO₃)ₚM^{p}.

As said, salt (S) used in Step (c0) can be a halide or a sulfate; yet, while sulfates are effective, halides may be preferred, as they may generate hydric acids as reaction products, which are easily removable/separable.

M^{p} can be an ammonium cation of formula NH₄⁺ with p=1. Yet, is preferably an alkaline metal cation or an alkaline earth metal cation, for increased thermal stability; it is even more preferable for M^{p} to be selected among alkaline metal cations, and most preferably M^{p} is any of Li, Na and K, and even most preferably Na and K.

Sulfates such as Na₂SO₄, K₂SO₄, NaHSO₄, KHSO₄ can be conveniently used.

The halide can be any halides, including also I and Br; yet, Cl and F are preferred.

The Salt (S) of formula M^{p}Xₚ is advantageously selected from the group consisting of NH₄Cl, LiCl, LiF, KCl, KF, NaCl, NaF, RbCl₂, RbF₂, CaCl₂, CaF₂, CsCl₂, CsF₂; as said, alkaline metal salts are preferred, so that LiCl, LiF, KCl, KF, NaCl, and NaF are used in those preferred embodiments, and even more preferably KCl, KF, NaCl, and NaF.

In Step (c0), the salt (S) is generally contacted with the molten mixture (M-HFSI) obtained from Step (b) in the solid state.

The salt (S) is generally delivered to the reaction vessel of Step (c0) under the form of a powder. The powdery salt (S) may be delivered to the reaction vessel of step (c0) through a powder conveyor, which may use pneumatic conveying means, including both pressure and vacuum pneumatic means; may use screw conveyor means, such as auger conveyors, helix conveyors, worm conveyor means or flexible screw conveyor means; may use belt conveying means; may use vibrating conveying means; or any other means adapted for dispensing powdery salt (S) into vessel (c0). Alternatively, (S) can be delivered as a slurry, as an example Na₂SO₄+NaHSO₄ in anhydrous H₂SO₄.

When the salt (S) is provided into step (b) under the form of a powder, it advantageously possesses an average particle size of less than 1000 μm.

In general, Step (c) comprises, possibly in addition to Step (c0), a step of distilling for obtaining the purified mixture (P-HFSI); distillation step can be carried out on the product obtained from Step (b) directly, can be carried out after Step (c0) and/or or can be carried out after completion of any preliminary separation step, such as e.g. any solid/liquid separation, in case the product from Step (b) and/or (c0) comprises any suspended solid.

A fractional distillation step is preferably carried out in Step (c), wherein the product obtained from the previous step is submitted to distillation at temperatures of 20 to 170° C., preferably of 25 to 100° C., even more preferably of 25 to 80° C.

The distillation, in particular the fractional distillation, may be carried out under atmospheric pressure, or may be carried out under reduced pressure; distillation temperatures will be adapted by one of ordinary skills in the art, depending upon the pressure applied.

Fractional distillation may be carried out continuously, or may be carried out batchwise.

When fractional distillation is carried out batchwise, upon heating the product obtained from the previous step in a boiler, a light fraction including e.g. HCl (when present) may be first evaporated and separated; by increasing boiler temperature, distillation of purified mixture (P-HFSI) including HFSI is then achieved. Hydrolysis products have lower volatilities, so that they are generally eliminated as residues in the boiler.

When fractional distillation is carried out continuously, a distillation column is generally used; purified mixture (P-HFSI) comprising compound of formula (I), e.g. HFSI, is generally recovered from the upper part of the column; light fractions, including e.g. HCl (when present) may be vented from the top, while the hydrolysed compounds will be eliminated as bottom products from the bottom of the column.

As said, the content of target chlorinated impurities in purified mixture (P-HFSI) is lower than in crude mixture (C-HFSI). Preferably, the target chlorinated impurities are present in purified mixture (P-HFSI) in an amount of less than 1000 ppm, preferably less than 500 ppm, even more preferably less than 150 ppm.

Should the disclosure of any patents, patent applications, and publications which are incorporated herein by reference conflict with the description of the present application to the extent that it may render a term unclear, the present description shall take precedence.

The invention will now be further described in examples, which are given by way of illustration and which are not intended to limit the specification or the claims in any manner.

### EXAMPLES

HFSI was supplied by PROVISCO CS

ClSO₃H was supplied by SIGMA-ALDRICH (product ID 571024, batch #BCCF1678)

96.4% H₂SO₄ was supplied by VWR (product ID 20700.298, batch #18C064006)

Target chlorinated impurities were determined as chloride anions after complete hydrolysis, by IC using a Dionex ICS-3000 system with conductivity detection, with the following components:
column: AS20 4*250 mm Analytical and AG20 4*50 mm Guard
suppressor: ASRS 300-4 mm, external water additional type.

The amount of Cl⁻ in HFSI was measured quantitatively after calibration using commercial standard solutions.

### Example: Selective Removal of ClSO₃H in HFSI

A 100 mL glass Schott bottle was loaded with 100.1 g HFSI notably comprising 0.557 g of ClSO₃H under dry argon atmosphere. The container is equipped with a 3-necks PTFE cap and a PTFE magnetic stirring bar. The reactor is fed with dry argon and the gas output is connected to an aqueous KOH scrubber. The concentration in chlorides measured by ion chromatography was found to be 1004 ppm.

The stirring was started at 600 rpm and then 4.45 g 96.4% H₂SO₄ were progressively added using a syringe and cannula connected to a syringe pump over 10 min. The medium was then sampled for ¹⁹F NMR analysis. The chlorides concentration was found to be lowered to 149 ppm.

1. A method of at least partially removing one or more target chlorinated impurities bearing at least one —SO₂Cl moiety from a crude bis(fluorosulfonyl)imide (HFSI) mixture comprising:
(i) a compound of formula (I) F—SO₂—NH—SO₂—R¹ (I) wherein R¹ represents F or Cl; preferably R¹ is F; and
(ii) the one or more said target chlorinated impurities bearing the at least one —SO₂Cl moiety, [crude mixture (C-HFSI)]; so as to create a purified HFSI mixture [purified mixture (P-HFSI)], the method comprising:
Step (a)—melting the crude mixture (C-HFSI) at a temperature exceeding the melting point of compound of formula (I), so as to obtain a molten mixture [molten mixture (M-FSI)];
Step (b)—contacting the crude mixture (M-HFSI) with (b1) water or with (b2) an aqueous acidic solution comprising water and at least one mineral acid, wherein the amount of water is of at most 50 equivalent for the total equivalent of target impurities present in crude mixture (C-HFSI), so as to cause at least partial hydrolysis of the said target chlorinated impurities thereby forming hydrolysed target chlorinated impurities; and
Step (c)—at least partially removing the hydrolysed target chlorinated impurities, so as to obtain a purified mixture [purified mixture (P-HFSI)].

2. The method of claim 1, wherein:
the mineral acid is selected from the group consisting of (i) hydric acids of formula HX, with X being a halogen selected from Cl, F, Br, and I; (ii) sulphuric acid; (iii) phosphoric and polyphosphoric acids; (iv) nitric acid; and (v) boric acid; and/or
the target chlorinated impurities bearing the at least one —SO₂Cl moiety are selected from the group consisting of bis(chlorosulfonyl) imide, (chlorosulfonyl fluorosulfonyl) imide, sulfamoyl chloride (NH₂SO₂Cl), chlorinated sulfonylimide oligomers; and chlorosulfonic acid.

3. The method of claim 1, wherein in step (a), crude mixture (C-HFSI) is molten, by raising the temperature beyond the melting point of compound (I); and at a temperature exceeding 18° C. when compound (I) is HFSI of formula: F—SO₂—NH—SO₂—F; and/or wherein crude mixture (C-HFSI) is molten under an atmosphere which is substantially exempt from moisture.

4. The method of claim 1, wherein step (b) is carried out in the substantial absence of any diluent, and wherein either no diluent is added, or if any diluent is present, its amount is less than 1 wt. % based on the total weight of the molten mixture (M-HFSI).

5. The method according to claim 1, wherein during step (b), HCl is generated and is removed from the molten mixture (M-HFSI) by venting the reaction vessel whereas Step (b) takes place; and/or
wherein removal of HCl is facilitated by operating under reduced pressure.

6. The method according to claim 1, wherein Step (b) is carried out at a temperature ranging from melting point of compound (I); and/or at a temperature up to 100° C.

7. The method according to claim 1, wherein the amount of water added as (b1) and/or (b2) is of at most 25 equivalents, based on the total equivalents of target impurities present in crude mixture (C-HFSI); and/or the amount of water at most 5, based on the total equivalents of target impurities present in crude mixture (C-HFSI).

8. The method according to claim 1, wherein the reaction in step (b) is carried out:
in batch mode, wherein a vessel is loaded with crude mixture (C-HFSI), and once the crude mixture C-HFSI) is molten to give the molten mixture (M-HFSI), (b1) and/or (b2) are added to the molten mixture (M-HFSI), and reacted until reaction is completed; or
in a semi-batch arrangement, wherein a vessel is charged with crude mixture (C-HFSI), which, after being submitted to step (a) of melting, is reacted progressively with (b1) and/or (b2), which is/are added continuously, either step-wise or portion-wise, or by continuous addition, and the molten mixture (M-HFSI) is reacted until completing the addition of (b1) and/or (b2); or
in a continuous mode, wherein molten mixture (M-HFSI) and (b1) and/or (b2) are fed simultaneously in a continuous manner to a reaction vessel.

9. The method according to claim 1, wherein Step (c) comprises a preliminary Step (c0) of contacting the mixture obtained from Step (b) with at least one Salt (S) of formula M^{p}Xₚ or M^{p}₂(SO₄)ₚ, whereas M^{p} is a metal cation of valence p or is an ammonium cation of valence p=1; X is a halide, and wherein the amount of Salt (S) is of 0.9 to 10 equivalent for each equivalent of target chlorinated impurities present in crude mixture (C-HFSI).

10. The method of claim 9, wherein M^{p} in Salt (S) is an ammonium cation of formula NH₄⁺ with p=1, or is an alkaline metal cation, or an alkaline earth metal cation.

11. The method of claim 10, wherein the Salt (S) of formula M^{p}Xₚ is selected from the group consisting of NH₄Cl, LiCl, LiF, KCl, KF, NaCl, NaF, RbCl₂, RbF₂, CaCl₂), CaF₂, CsCl₂, CsF₂.

12. The method according to claim 1, wherein Step (c) comprises, optionally in addition to Step (c0), a step of distilling for obtaining the purified mixture (P-HFSI):
wherein the product obtained from the previous step is submitted to distillation at temperatures of 20 to 170° C., and/or
wherein the distillation is carried out under atmospheric pressure or under reduced pressure.

13. The method of claim 12, wherein Step (c) comprises a step of fractional distillation which is carried out continuously, and wherein a distillation column is used; and purified mixture (P-HFSI) comprising compound of formula (I) is recovered from an upper part of the column and the hydrolysed compounds are eliminated as bottom products from a bottom of the column.

14. The method according to claim 1, wherein the content of target chlorinated impurities in purified mixture (P-HFSI) is of less than 1000 ppm.

15. The method according to claim 1, wherein Step (b) is performed in a stirred vessel adapted for ensuring intimate contact between molten HFSI and (b1) and/or (b2).
